(19) United States
(12) Patent Application Publication
(10) Pub. No.: US 2009/0285425 A1
(43) Pub. Date: Nov. 19, 2009

(54) Solar powered hearing aid

(75) Inventors: Samuel L. Thomasson, Gilbert, AZ (US); Fan Wu, Scottsdale, AZ (US)

Correspondence Address: Paul F. Wille, 6407 East Clinton St., Scottsdale, AZ, 85254, US

(73) Assignee: Zounds, Inc., Mesa, AZ (US)

(21) Appl. No.: 12/152,751

(22) Filed: May 16, 2008

(51) Int. Cl. H04R 25/00

(52) U.S. Cl. 381/323

(57) ABSTRACT

A hearing aid includes a case, a photovoltaic cell located within the case, and a light gathering member optically coupled to the photovoltaic cell. The photovoltaic cell is preferably a multi-junction cell and the light gathering member gathers light at the wavelengths preferentially absorbed by the multi-junction cell.

This invention relates to hearing aids and, in particular, to a hearing aid powered by a photovoltaic cell in the hearing aid.

### BACKGROUND TO THE INVENTION

As used herein, a “primary” battery is one that is not intended for charging even though, in fact, one can safely recharge the battery one or a few times. A “secondary” battery is one that is intended for recharging a plurality of times. In general, primary batteries have a greater capacity (store more energy) than rechargeable batteries. Secondary batteries have a different internal structure from primary batteries, even when the chemistry involved is nominally the same.

Hearing aids powered by a battery have been known for almost a century; see U.S. Pat. No. 1,219,411 (Williams), for example. Modern technology has increased battery life greatly, yet it is annoying to have to replace batteries. Rechargeable batteries are a partial solution but require removal of the hearing aid and placement in a charger. Unless a user has two sets of hearing aids, the charging can be inconvenient.

Hearing aids having rechargeable batteries have been known in the art for a long time; e.g., see U.S. Pat. No. 3,297,933 (McCarthy). The trade-off between rechargeable batteries and non-rechargeable batteries is the inconvenience of having to replace the battery. There is also a trade-off in capacity. A non-rechargeable battery lasts much longer than a rechargeable battery having the same outside dimensions as the non-rechargeable battery.

The need to replace batteries means that one must open a hearing aid. Moisture, wax, dirt, oils and so on, can work their way into a hearing aid, causing problems. Hearing aids can be made relatively impervious to ambient conditions. A hearing aid that is relatively impervious is also likely to be relatively difficult to open for a user.

The inconvenience of having to remove the battery from a hearing aid initially applied both to rechargeable batteries and non-rechargeable batteries. The sole advantage of rechargeable batteries was not having to be replaced. Then, chargers were developed that made electrical contact with the hearing aid, obviating the need to remove the rechargeable battery; e.g. see U.S. Pat. No. 3,493,695 (Stork). This simplified matters for those lacking the dexterity to remove and insert a battery. Having exposed electrical contacts is undesirable and inductive chargers solved this problem; e.g. see U.S. Pat. No. 4,379,988 (Mattatall).

Inductive chargers have their own set of difficulties, including adequate coupling between the primary inductor in the charger and the secondary inductor in the hearing aid; e.g. see U.S. Pat. No. 6,658,124 (Meadows). Even with adequate coupling, rechargeable batteries are not a panacea.

Using light to recharge the battery in a hearing aid is disclosed in U.S. Pat. No. 5,210,804 (Schmid) and U.S. Pat. No. 5,253,300 (Knapp). In the Schmid patent, a photovoltaic cell is behind a semi-transparent door in a hearing aid. The cell does not recharge the battery during use. At night, the door is opened and the hearing aid is placed in a stand that shines light from lamps onto the photovoltaic cell. In the Knapp patent, the solar cell is external to the hearing aid, part of a recharging case. U.S. Pat. No. 5,303,305 (Raimo et al.) discloses a hearing aid powered by a secondary battery that is recharged by a solar cell on the hearing aid.

The ordinary and accepted meaning of “translucent” is capable of transmitting light but causing sufficient diffusion to eliminate perception of distinct images. As used herein, “translucent” means capable of transmitting more than fifty percent of light incident normal to a surface. Thus, “translucent” includes media that is transparent.

In view of the foregoing, it is therefore an object of the invention to provide more power to a hearing aid from a photovoltaic cell than has been provided in the past.

A further object of the invention is to provide a hearing aid having a photovoltaic cell that can charge the battery in the hearing aid even when the hearing aid is worn indoors.

Another object of the invention is to provide a hearing aid with a photovoltaic cell and a light gathering member.

A further object of the invention is to provide a hearing aid with a photovoltaic cell having improved conversion efficiency.

### SUMMARY OF THE INVENTION

The foregoing objects are achieved by this invention in which a hearing aid includes a case, a photovoltaic cell located within the case, and a light gathering member optically coupled to the photovoltaic cell. The photovoltaic cell is preferably a multi-junction cell and the light gathering member gathers diffuse light at the wavelengths preferentially absorbed by the multi-junction cell.

### BRIEF DESCRIPTION OF THE DRAWINGS

A more complete understanding of the invention can be obtained by considering the following detailed description in conjunction with the accompanying drawings, in which:

FIG. 1 illustrates a hearing aid constructed in accordance with a preferred embodiment of the invention;

FIG. 2 is a cross-section of a photovoltaic cell having plural junctions;

FIG. 3 illustrates a light gathering member and the top portion of the hearing aid illustrated in FIG. 1;

FIG. 4 is a diagram illustrating the operation of the light gathering member; and

FIG. 5 is a block diagram of a charging circuit in the hearing aid illustrated in FIG. 1.

### DETAILED DESCRIPTION OF THE INVENTION

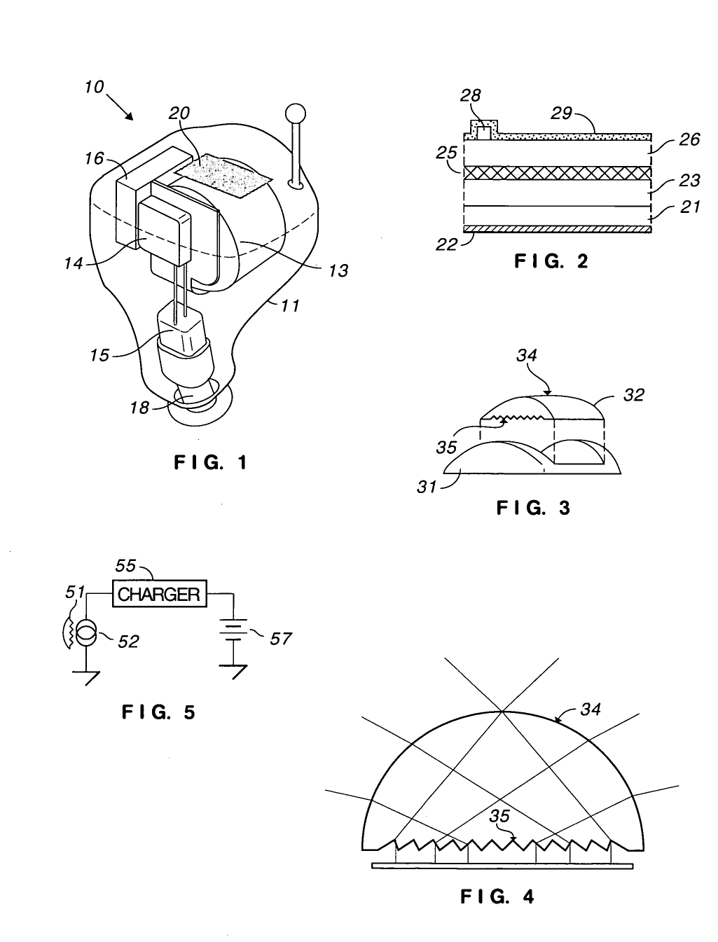

In FIG. 1, hearing aid 10 includes body 11 containing battery 13, electronics 16, and speaker 15. For historical reasons, a speaker is sometimes referred to as a “receiver” in the hearing aid art. That is not the terminology being used herein. A hearing aid has at least one speaker and at least one microphone, such as microphone 14. Hearing aid 10 is known as an ITC (in-the-canal) type of hearing aid. Speaker 15 is coupled to the ear canal by tube 18. The body of the hearing aid rests in the outer ear or auricle.

In accordance with one aspect of the invention, hearing aid 10 includes photovoltaic cell 20. This cell is electrically coupled to electronics 16 and is both a source of power for operating the hearing aid and a source of current for recharging battery 13.

Cell 20 is preferably what is known in the art as a multi-junction cell. For example, U.S. Pat. No. 6,252,287 (Kurtz et al.) discloses a veritable parfait of semiconductor layers in a multi-junction solar cell. FIG. 2 illustrates a somewhat simpler structure, with fewer layers. The layers of semiconductive material have different band gaps and, combined, absorb preferentially at several wavelengths, rather than one. This increases the amount of electrical energy produced by the cell. There are many combinations of layers possible. FIG. 2 illustrates one combination that has been found suitable.

Germanium (Ge) substrate 21 is coated on one surface by gold contact layer 22. Overlying substrate 21 is GaAs layer 23. Overlying GaAs layer 23 is lattice matching, tunnel junction layer 25. Overlying layer 25 is GaInP layer 26. Contact stripe 28 provides electrical contact to layer 26. Anti-reflection coating 29 overlies layer 26 and stripe 28.

The band gaps are arranged in descending order, from top to bottom as the layers are arranged in FIG. 2. The shortest wavelength (highest energy) is absorbed by layer 26, which has a band gap of 1.85 eV. Layer 23 has a band gap of 1.42 eV and layer 21 has a band gap of 0.74 eV. Cell 20 has an open circuit voltage of approximately 2.6 volts. Output current varies with the amount of available light.

In accordance with another aspect of the invention, the case of a hearing aid includes a lenticular portion in order to increase the amount of power available from the solar cell. FIG. 3 illustrates a preferred embodiment of the invention in which top 31 of hearing aid 10 (FIG. 1) receives translucent, lenticular member 32. As a separate piece, it is easier to control the optical properties of member 32. Preferably, member 32 gathers diffuse light at the wavelengths absorbed by cell 20. Member 32 is fastened to the case with a suitable adhesive.

Member 32 is lenticular in the sense that light incident upon the member is redirected to a smaller angle of incidence on the underlying photovoltaic cell, as illustrated in FIG. 4. The light is gathered or “collimated” somewhat but not in the sense that light rays are necessarily made parallel. Member 32 preferably includes convex upper surface 34 and corrugated lower surface 35 for gathering light. To some extent, the degree of curvature of upper surface 34 depends upon the type and design of the hearing aid. The lens can be cylindrical, spherical, or a compound surface. Lower surface 35 can be prismatic or Fresnel. Transparent acrylic is a preferred material for member 32. Polycarbonate or other materials can be used instead.

As illustrated in FIG. 5, light gathered by optical member 51 is incident upon multi-junction photovoltaic cell 52, causing the cell to convert some of the light to electric current. The current is coupled to charger 55, which converts the current to a suitable current and voltage for battery 57. As known in the art, different types of batteries require different charging procedures. For some a continuous, if varying, current is sufficient. Other batteries are preferably charged by a pulse width modulated current. In any case, charger 55 provides the proper charging conditions and limits charging when it senses that battery 57 is charged. Whatever the charging procedure, an increased amount of energy is available because of light gathering member 51 and the plurality of junctions in cell 52.

The invention thus can provide more power to a hearing aid from a photovoltaic cell than has been provided in the past. The battery in the hearing aid can be charged even when the hearing aid is worn indoors. A hearing aid constructed in accordance with the invention includes an integral light gathering member; that is, the light gathering member is aesthetically a part of the hearing aid and not noticeable to casual view as a separate element. The light gathering member improves photovoltaic conversion efficiency, thereby permitting a smaller battery or longer use between charges in an external charger.

Having thus described the invention, it will be apparent to those of skill in the art that various modifications can be made within the scope of the invention. For example, the invention is applicable to hearing aids other than the types illustrated in FIG. 1, such as BTE (behind-the-ear) hearing aids. Member 32 can be part of the case for a hearing aid, with light gathering features molded into the case at an appropriate location when the case is made. As illustrated, member 32 has the combination of an upper surface that is continuous and a lower surface that is discontinuous (has corners). The other three combinations (both continuous, both discontinuous, or discontinuous outer and continuous inner) are feasible but are not preferred. Although any light source can provide energy, a continuous spectrum source, e.g. solar or incandescent lamp, is preferred over limited spectrum lighting, such as fluorescent lamps, which may have little output in the desired band gaps.

What is claimed as the invention is:

1. A hearing aid including a case containing electronics for processing audio signals, a battery for powering the electronics, and a photovoltaic cell for charging the battery characterized in that:
the photovoltaic cell is located within the case; and
the case includes a light gathering member optically coupled to said photovoltaic cell.

2. The hearing aid as set forth in claim 1 wherein said photovoltaic cell is a multi-junction cell.

3. The hearing aid as set forth in claim 1 wherein said light gathering member is translucent and has a convex surface.

4. The hearing aid as set forth in claim 1 wherein said light gathering member has a corrugated surface.

5. The hearing aid as set forth in claim 1 wherein said light gathering member has a convex outer surface and a corrugated inner surface.

6. The hearing aid as set forth in claim 1 wherein said photovoltaic cell is a multi-junction cell and the light gathering member gathers light at the wavelengths preferentially absorbed by the multi-junction cell.

7. A hearing aid comprising a case, a photovoltaic cell located within the case, and a light gathering member optically coupled to the photovoltaic cell.

8. The hearing aid as set forth in claim 7 wherein said light gathering member is molded into and is part of the case.

9. The hearing aid as set forth in claim 7 wherein said light gathering member is a component attached to the case.

10. The hearing aid as set forth in claim 7 wherein said light gathering member has a convex surface.

11. The hearing aid as set forth in claim 7 wherein said light gathering member has a corrugated surface.
